(19) United States
(12) Patent Application Publication
(10) Pub. No.: US 2006/0170364 A1
(43) Pub. Date: Aug. 3, 2006

(54) Light modulating lamp stand

(75) Inventor: Wen Ho Yang, Taipei Hsien (TW)

Correspondence Address: BACON & THOMAS, PLLC, 625 SLATERS LANE, FOURTH FLOOR, ALEXANDRIA, VA, 22314, US

(73) Assignee: Sun Lite Sockets Industry Inc., Taoyuan Hsien (TW)

(21) Appl. No.: 11/045,291

(22) Filed: Jan. 31, 2005

(51) Int. Cl. H01J 7/44

(52) U.S. Cl. 315/59

(57) ABSTRACT

A light modulating lamp stand includes a columnar holder having a chamber for receiving a lamp and formed with a first and a second electrode terminal, a circuit board installed on the holder and formed with a first and a second power connecting terminal and a SCR connected with the second electrode terminal of the circular holder and the second power connecting terminal of the circuit board. The SCR has its anode and cathode connected in parallel with an adjustable resistance and a capacitor connected in series. The capacitor has one terminal connected with the second power connecting terminal of the circuit board, and a trigger diode is connected with the other terminal of the capacitor and the gate electrode of the SCR. Thus, brightness of the lamp can be modulated by adjusting and changing resistance value of the adjustable resistance.

### BACKGROUND OF THE INVENTION

1. Field of the Invention

This invention relates to a light modulating lamp stand, particularly to one adaptable to different AC powers.

2. Description of the Prior Art

A light modulating lamp stands for receiving a lamp and able to modulate the light intensity of the lamp is widely applied to apparatus that require modulation of light brightness.

The circuit of a conventional light modulating light stand, as shown in FIG. 4, includes a columnar holder 1 provided between a SCR (silicon controlled rectifier) and a contact (C) and formed with a chamber for receiving a lamp, a first power connecting terminal (A) and a second power connecting terminal (B) respectively for connecting a power line. A light modulating circuit is provided between the holder 1 and the first and the second power connecting terminal (A), (B) for carrying out light modulation. The light modulating circuit is provided with an adjustable resistance (W) and a capacitor (C) connected in series with the first and the second power connecting terminal (A) and (B). A trigger diode (D) is connected with the capacitor (C) and the gate electrode of a SCR to form a trigger circuit.

The trigger current of the SCR has a limiting value. When current becomes very high to exceed the limiting value, it may pierce through the SCR. Since the trigger circuit is connected with the first and the second power connecting terminal (A) and (B) with high voltage; therefore, a current-limiting resistance (R) has to be connected in series with the opposite terminals of the adjustable resistance (W). Thus, when the adjustable resistance (W) is adjusted to become low gradually, the trigger return current can be prevented from becoming excessively high and damaging the SCR. When the voltages of a power source is 120 volts or 220 volts, adjustable resistance with different resistance values has to be altered and current-limiting resistance also has to be changed, thus changing process of the circuit is complicated.

### SUMMARY OF THE INVENTION

The objective of the invention is to offer a light modulating lamp stand applicable to different AC current powers under a condition of not changing its electronic elements.

The light modulating lamp stand in the present invention includes a columnar holder having a chamber for receiving a lamp and formed with a first and a second electrode terminal. A circuit board assembled on the circular holder is formed with a first and a second power connecting terminal. A SCR is provided between and connected with the second electrode terminal of the circular holder and the second power connecting terminal of the circuit board, having its anode and cathode connected in parallel with an adjustable resistance and a capacitor connected in series with the adjustable resistance. The capacitor has one terminal connected with the second power connecting terminal of the circuit board, with a trigger diode provided between the other terminal of the capacitor and the gate electrode of the SCR.

### BRIEF DESCRIPTION OF DRAWINGS

This invention will be better understood by referring to the accompanying drawings, wherein:

FIG. 1 is a perspective view of a light modulating lamp stand in the present invention:

FIG. 2 is an exploded perspective view of the light modulating lamp stand in the present invention:

FIG. 3 is a circuit diagram of the light modulating lamp stand in the present invention: and

FIG. 4 is a circuit diagram of a conventional light modulating lamp stand.

### DETAILED DESCRIPTION OF THE PREFERRED EMBODIMENT

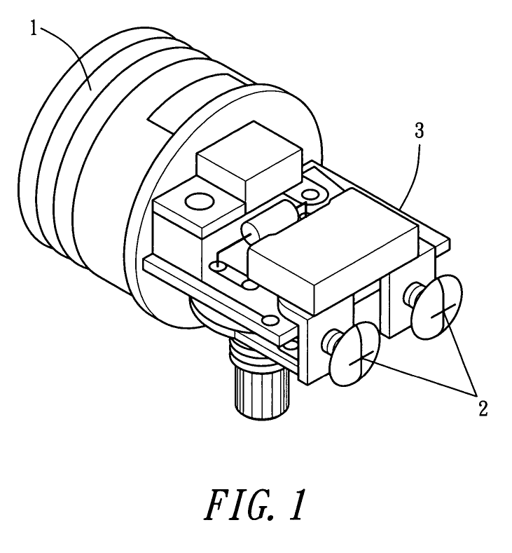

A preferred embodiment of a light modulating lamp stand in the present invention, as shown in FIG. 1, includes a columnar holder 1 formed with threads and a chamber for receiving a lamp. A circuit board 3 is disposed at one end opposite to the chamber of the columnar holder 1 for carrying out modulation of light intensity, having two connecting contacts 2 respectively screwed with a bolt for connecting a power conductive line.

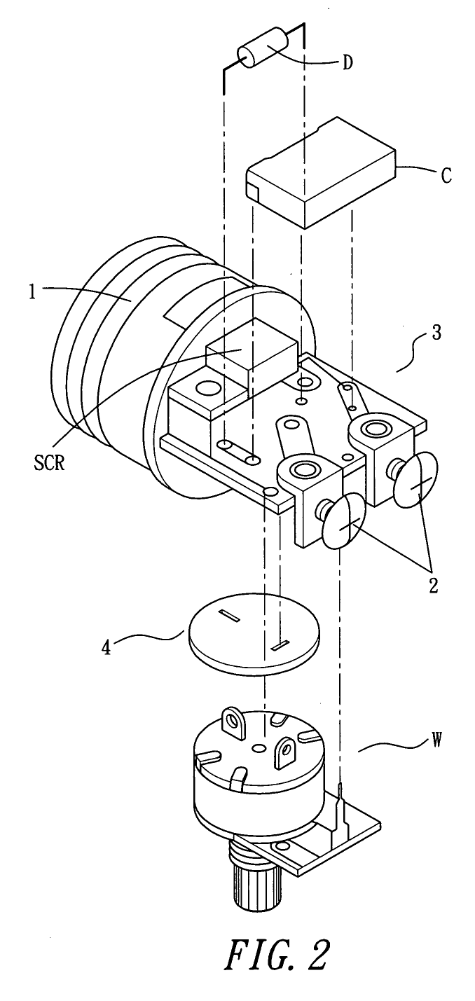

Referring to FIG. 2, the circuit board 3 positioned on the circular holder 1 could be a double-sided circuit board assembled thereon with an adjustable resistance (W), a capacitor (C), A SCR (a TRIAC (triode AC switch) also usable) and a trigger diode (D) (a DIAC (diode AC switch) also useable), with an insulation spacer 4 provided between the adjustable resistance (W) and the circuit board 3.

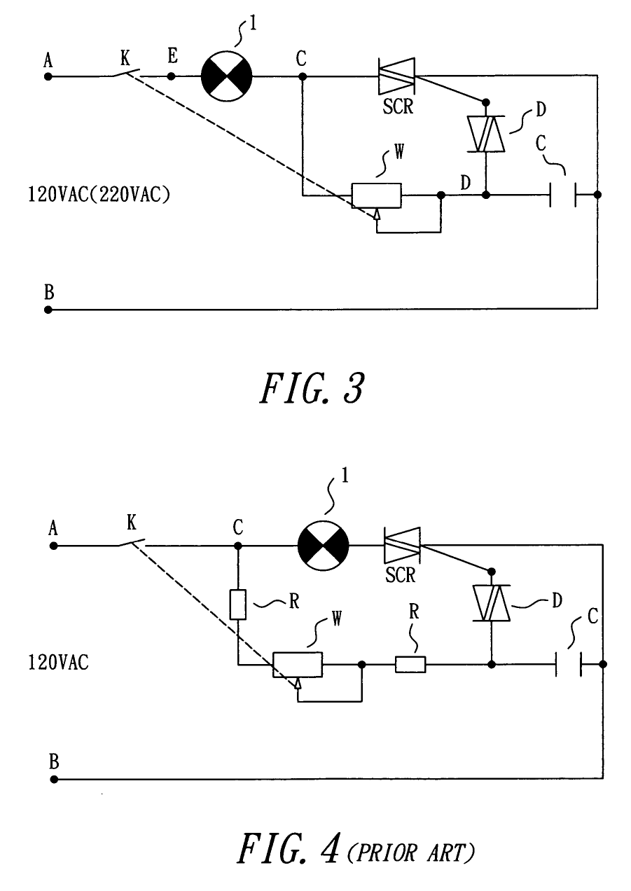

The circuit of the light modulating lamp stand of this invention, as shown in FIG. 3, includes the columnar holder 1 formed with a first electrode terminal (E) and a second electrode terminal (C). The circuit board 3 is provided with a first power connecting terminal (A) and a second power connecting terminal (B). The SCR is provided between and connected with the second electrode terminal (C) of the columnar holder 1 and the second power connecting terminal (B) of the circuit board 3, having the terminal of its anode and cathode connected in parallel with the adjustable resistance (W) and the capacitor (C) connected in series with the adjustable resistance (W). The capacitor (C) has one terminal connected with the second power connecting terminal (B) of the circuit board 3, and the trigger diode (D) is provided between the other terminal (the dot D in FIG. 3) of the capacitor (C) and the gate electrode of the SCR to form a control circuit for triggering the SCR.

The brightness of the lamp can be modulated by adjusting the resistance value of the adjustable resistance (W). When the resistance is adjusted from high to low, voltage between dot D and dot B indicated in FIG. 3 will rise and the lamp installed on the columnar holder 1 will become brighter gradually. On the contrary, when the resistance of the adjustable resistance (W) is adjusted from low to high, voltage between the first electrode terminal (E) and the second electrode terminal (C) of the circular holder 1 will drop and the lamp on the columnar holder 1 will become dimmer gradually. Specifically, trigger voltage and trigger current will be changed together with the change of the resistance value of the adjustable resistance (W). Further, the adjustable resistance (W) is provided with a switch (K) positioned between and connected in series with the second electrode terminal (E) of the columnar holder 1 and the first power connecting terminal (A) of the circuit board 3 for controlling On and Off of the power of the whole circuit.

In addition, the circuit board 3 in this invention is a double-sided circuit board. Then the adjustable resistance (W) can be fixed on one side of the circuit board 3, and the SCR, the capacitor (C) and the trigger diode (D) can be welded on the other side of the circuit board 3. letting the SCR and the capacitor (C) flatly positioned on the circuit board by means of folding, forming a closely-combined structure and diminishing the whole dimension of the stand to be easily connected with the electrodes of the columnar holder 1.

In the present invention, the current limit resistance (R) used in the conventional stand is not used, so the circuit can become more simple and can use different AC source only by changing the adjustable resistance.

As can be understood from the above description, this invention has the following advantages:

1. The circuit is simple in structure, needless to additionally provide a current-limiting resistor R.

2. It only has to replace the adjustable resistance in order to match with different AC powers.

3. The whole dimension of the stand is small and the cost is low, having industrial universal adaptability.

While the preferred embodiment of the invention has been described above, it will be recognized and understood that various modifications may be made therein and the appended claims are intended to cover all such modifications that may fall within the spirit and scope of the invention.

I claim:

1. A light modulating lamp stand comprising:
A columnar holder formed with a chamber for receiving a lamp, said columnar holder formed with a first electrode terminal and a second electrode terminal;
A circuit board assembled on said columnar holder, said circuit board formed with a first power connecting terminal and a second power connecting terminal, a SCR connected with said second electrode terminal of said circular holder and said second power connecting terminal of said circuit board, said SCR having its anode and cathode connected in parallel with an adjustable resistance and a capacitor connected in series with said adjustable resistance, said capacitor having one terminal connected with said second power connecting terminal of said circuit board, and a trigger diode connected with the other terminal of said capacitor and the gate of said SCR.

2. The light modulating lamp stand as claimed in claim 1, wherein said circuit board is a double-sided circuit board.

3. The light modulating lamp stand as claimed in claim 1, wherein said adjustable resistance is provided with a switch connected in series with said second electrode terminal of said columnar holder and said first power connecting terminal of said circuit board.
